(19) United States
(12) Patent Application Publication
(10) Pub. No.: US 2011/0216058 A1
(43) Pub. Date: Sep. 8, 2011

(54) Display device and operating method thereof

(76) Inventor: Hyun-Uk Oh, Yongin-City (KR)

(21) Appl. No.: 12/926,768

(22) Filed: Dec. 8, 2010

(30) Foreign Application Priority Data
Mar. 5, 2010 (KR) 10-2010-0020101

(51) Int. Cl. G09G 5/00

(52) U.S. Cl. 345/213

(57) ABSTRACT

A data driver connected to the display panel and applying an image data signal to the plurality of pixels; a scan driver connected to the display panel and applying an image scan signal to the plurality of pixels for the image data signal to be applied to the plurality of pixels, and a signal controller controlling the data driver and the scan driver. The data driver applies a data signal having a predetermined pattern to the display panel in a data porch period for adjusting synchronization between frames. The data signal applied during the data porch period may be determined in accordance with frames adjacent the data porch period.

### BACKGROUND OF THE INVENTION

1. Field

Embodiments relate to a liquid crystal display (LCD). More particularly, embodiments relate to a liquid crystal display operated with an ALS driving method.

2. Description of the Related Art

As a representative display device, a liquid crystal display (LCD) includes two display panels respectively having pixel electrodes and a common electrode, and a liquid crystal layer having dielectric anisotropy therebetween. The pixel electrodes are arranged in a matrix form on a first display panel. Each pixel electrode is connected to a switching element, e.g., a thin film transistor (TFT), to sequentially receive a data voltage row by row. The common electrode is formed over an entire surface of the second display panel to receive a common voltage. A pixel electrode, the common electrode, and the liquid crystal layer therebetween constitute a liquid crystal capacitor from an equivalent circuit view. The liquid crystal capacitor and a switching element connected thereto form a basic unit of a pixel for the LCD.

In the LCD, an electric field is generated in a liquid crystal layer by applying a voltage to the two electrodes, and a desired image is obtained by adjusting transmittance of light passing through the liquid crystal layer through adjusting intensity of the electric field. In order to prevent a degradation phenomenon that occurs when the electric field is applied in the liquid crystal layer in one direction for a long time, polarities of the data voltage with respect to a common voltage are inverted, e.g., for every frame, every row, or every pixel.

The ALS driving method is a driving method for boosting a voltage of a pixel by boosting the voltage of a pixel electrode that is floated after a gate voltage is off by coupling with a voltage of an ALS line. The boosting of the voltage of the pixel electrode may be induced by increasing or decreasing the voltage of the ALS line during one frame. The ALS driving method may reduce a source output voltage of a driving circuit, thereby reducing the power consumption.

Also, the ALS driving method may increase the pixel voltage, and the response speed of the liquid crystal may be improved through the application of the increased pixel voltage. Using the ALS driving method, the source data voltage may be sufficiently applied within a small changing width such that the common electrode signal may be applied with a DC voltage. Accordingly, audible noise, which is a problem associated with using line inversion driving, may be reduced.

However, the ALS line is along the gate direction such that it overlaps the data line, and the voltage of the ALS line to be applied as the DC voltage during one frame may have noise due to coupling with the data line. If the voltage of the ALS line has noise, noise of the boosted voltage of the pixel electrode increases, such that the voltage applied to the liquid crystal is not stable. Accordingly, screen flickering may be serious.

Particularly, if the data voltage swings between maximum and minimum voltages in a data porch period, the noise of the ALS line due to coupling with the data line may be further increased. The data porch period is a time generated between frames to control a frame sink.

If the change of the boosted voltage of the pixel electrode data increases in the data porch period, the change of the luminance of the LCD becomes increased, thereby generating flicker. For example, if the operation frequency of the LCD is 60 Hz (or 30 Hz), the change of the luminance by the ALS noise in the data porch period also has a frequency of 60 Hz. Thus, the LCD operated according to the ALS driving method performs poorly with regard to flicker.

The above information disclosed in this Background section is only for enhancement of understanding of the background of the invention and therefore it may contain information that does not form the prior art that is already known in this country to a person of ordinary skill in the art.

### SUMMARY

Embodiments are therefore directed to a display device and operating method thereof, which substantially overcome one or more of the problems due to the limitations and disadvantages of the related art.

It is therefore a feature of an embodiment to provide a display device and a driving method capable of reducing flicker while using the ALS driving method.

At least one of the above and other features and advantages may be realized by providing a display including a display panel including a plurality of pixels, a data driver connected to the display panel, the data driver applying an image data signal to the plurality of pixels, a scan driver connected to the display panel, the scan driver applying an image scan signal to the plurality of pixels for the image data signal to be applied to the plurality of pixels, and a signal controller controlling the data driver and the scan driver, wherein the data driver applies a data signal having a predetermined pattern to the display panel in a data porch period for adjusting synchronization between frames.

The data signal having the predetermined pattern in the data porch period may have a same period as the image data signal applied in the frame before the data porch period.

The data signal having the predetermined pattern in the data porch period has the same period as the image data signal applied in the frame after the data porch period.

The data signal having the predetermined pattern in the data porch period may include a positive intermediate value between a positive voltage applied in the frame adjacent the data porch period and the common voltage. The data signal having the predetermined pattern in the data porch period may alternate between the common voltage and the positive intermediate value. The data signal may be a DC voltage of the intermediate value. The intermediate value may be ½ the positive voltage applied in the frame adjacent the data porch period.

The data voltage having the predetermined pattern in the data porch period may include a negative intermediate value between a negative voltage applied in the frame adjacent the data porch period and the common voltage. The data signal having the predetermined pattern in the data porch period may alternate between the common voltage and the negative intermediate value. The data signal is a DC voltage of the intermediate value. The intermediate value may be ½ the negative voltage applied in the frame adjacent the data porch period.

The data porch period may include a first period at a start of the data porch period, the first period adjacent a first frame, and a second period at an end of the data porch period, the second period adjacent a second frame, the first and second periods having data signals in accordance with image data signals applied during the first and second frames, respectively. The data driver may apply the image data signal voltage for the first and second frames during the first and second periods of the data porch period, respectively. The data driver may alternately apply a common voltage and a first intermediate voltage during the first period of the data porch period, the first intermediate voltage being between the common voltage and a data voltage of the first frame, and the common voltage and a second intermediate voltage during the second period of the data porch period, the second intermediate voltage being between the common voltage and a data voltage of the second frame. The data driver may apply a DC voltage of a first intermediate voltage during the first period of the data porch period, the first intermediate voltage being between a common voltage and a data voltage of the first frame, and apply a DC voltage of a second intermediate voltage during the second periods of the data porch period, the second intermediate voltage being between the common voltage and a data voltage of the second frame.

The display device may include a gray voltage generator providing a grayscale voltage to the data driver in the data porch period.

At least one of the above and other features and advantages may be realized by providing a method for driving a display device having a plurality of pixels, the method including applying an image data signal to the plurality of pixels, applying an image scan signal to the plurality of pixels for the image data signal to be applied to the plurality of pixels thereby displaying an image of a frame, and applying a data voltage of a predetermined pattern to the plurality of pixels in a data porch period between a completion of the display of a first frame and a start of a second frame.

Applying the data voltage of the data porch period may include selecting grayscale data voltages to be applied.

Applying the data voltage of the predetermined pattern to the plurality of pixels in the data porch period may include applying the image data signal.

Applying the data voltage of the predetermined pattern to the plurality of pixels in the data porch period may include applying the image data signal of the first frame during a first period at a start of the data porch period, and applying the image data signal of the second frame during a second period at an end of the data porch period.

Applying the data voltage of the predetermined pattern may include applying a first intermediate voltage during a first period at a start of the data porch period, the first intermediate voltage being between the common voltage and a data voltage of the first frame, and applying a second intermediate voltage during a second period at an end of the data porch period, the second intermediate voltage being between the common voltage and a data voltage of the second frame.

Applying the data signal of the predetermined pattern may include applying the first intermediate voltage as a DC voltage during the first period and applying the second intermediate voltage as a DC voltage during the second period. The first and second intermediate voltages may be halfway between the common voltage and the data voltages of the first and second frames, respectively.

Applying the data signal of the predetermined pattern may include alternately applying the first intermediate voltage and the common voltage during the first period, and alternately applying the second intermediate voltage and the common voltage during the second period.

At least one of the above and other features and advantages may be realized by providing a data driver for driving a display panel having a plurality of pixels, the driving driver including an image signal drive outputting an image data signal to be provided to the plurality of pixels frame by frame, and a data porch drive outputting a data signal having a predetermined pattern to be provided to the plurality of pixels in a data porch period for adjusting synchronization between frames.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a liquid crystal display (LCD) according to an exemplary embodiment.

FIG. 2 illustrates an equivalent circuit of one pixel of FIG. 1.

FIG. 3 illustrates a circuit diagram to explain an operation of a liquid crystal display (LCD) of FIG. 1.

FIG. 4 illustrates a waveform diagram according to an exemplary embodiment to explain an operation of a liquid crystal display (LCD) of FIG. 1.

FIG. 5 illustrates a waveform diagram according to another exemplary embodiment to explain an operation of a liquid crystal display (LCD) of FIG. 1.

FIG. 6 illustrates a waveform of a data voltage applied to one data line among a plurality of data lines in a porch period according to an exemplary embodiment.

FIG. 7 illustrates a waveform of a data voltage applied to one data line among a plurality of data lines in a porch period according to another exemplary embodiment.

FIG. 8 illustrates a waveform of a data voltage applied to one data line among a plurality of data lines in a porch period according to another exemplary embodiment.

### DETAILED DESCRIPTION

Korean Patent Application No. 10-2010-0020101 filed in the Korean Intellectual Property Office on Mar. 5, 2010, and entitled: “Display Device and Operating Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Furthermore, with exemplary embodiments, a detailed description is given as to the constituent elements in the first exemplary embodiment with reference to the relevant drawings by using the same reference numerals for the same constituent elements, while only the constituent elements that are different from those related to the first exemplary embodiment are described in other exemplary embodiments.

Parts that are irrelevant to the description are omitted in order to clearly describe the present invention, and like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

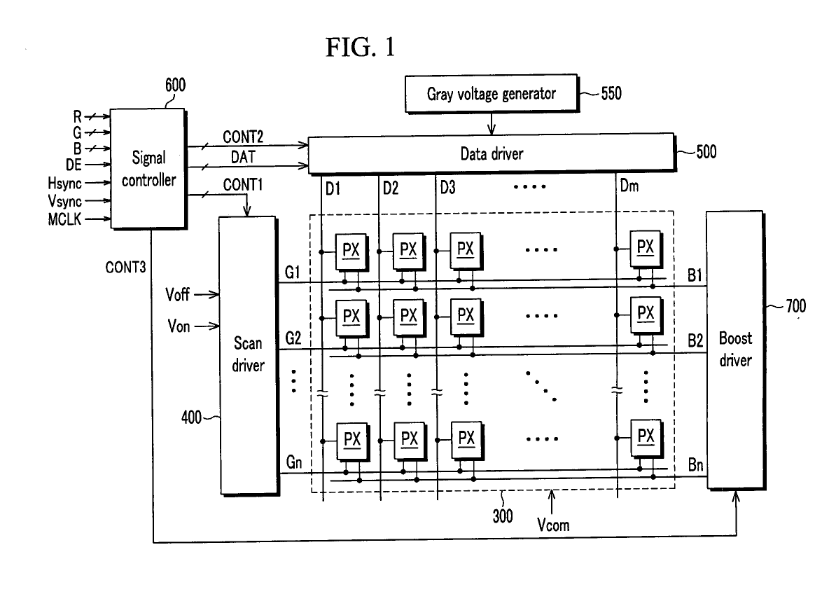

A liquid crystal display (LCD) and a driving method according to exemplary embodiments will be described with reference to FIGS. 1 to 6.

FIG. 1 illustrates a block diagram of a liquid crystal display (LCD) according to an exemplary embodiment of the present invention. Referring to FIG. 1, an LCD includes an LCD panel assembly 300, a scan driver 400, a data driver 500, a gray voltage generator 550, a boost driver 700, and a signal controller 600.

The LCD panel assembly 300 includes a plurality of gate lines G1-Gn, a plurality of data lines D1-Dm, a plurality of boost lines B1-Bn, and a plurality of pixels PX. The pixels PX are connected to the plurality of signal lines G1-Gn, D1-Dm, and S1-Sn, and are arranged in an approximate matrix. The gate lines G1 to Gn extend in an approximate row direction and are substantially parallel to each other. The boost lines B1-Bn correspond to the gate lines G1-Gn thereby extending in the approximate row direction. The data lines D1 to Dm extend in a column direction and substantially parallel to each other. At least one polarizer (not shown) polarizing light is on an outer surface of the LCD panel assembly 300.

The signal controller 600 receives video signals R, G, and B, and input control signals controlling the display thereof. The input control signals may include, for example, a horizontal synchronization signal Hsync, a vertical synchronization signal Vsync, a data application region signal DE, a main clock signal MCLK, and so forth. The signal controller 600 provides the image data signal DAT and the data control signal CONT2 to the data driver 500. The data control signal CONT2 as a signal controlling an operation of the data driver 500 includes a horizontal synchronization start signal STH for notifying a transmission start of digital image signal DAT, a load signal LOAD for instructing the output of the data voltage to the data lines D1-Dm, and a data clock signal HCLK. The data control signal CONT2 may further include an inversion signal RVS that inverts the voltage polarity of the data voltage with respect to the common voltage Vcom.

The signal controller 600 provides a scan control signal CONT1 to the scan driver 400. The scan control signal CONT1 includes at least one clock signal controlling the output of the scan start signal STV and a gate on voltage Von in the scan driver 400. The scan control signal CONT1 may further include an output enable signal OE for restricting the duration time of a gate on voltage.

The signal controller 600 provides a boost control signal CONT3 to the booster driver 700. The boost control signal CONT3 controls the output of the boost voltage Vboost from the boost driver 700 to the boost lines B1-Bn.

The data driver 500 is connected to the data lines D1-Dm of the LCD panel assembly 300 and selects a gray voltage from the gray voltage generator 550. The data driver 500 applies the selected gray voltage to the data lines D1-Dm as the image data signals. The gray voltage generator 550 need not provide the voltages for the entire grayscale, but may only provide the reference gray voltage of the determined number. Here, the data driver 500 divides the reference gray voltage to generate gray voltages for the entire grayscale and may select the image data signal among them. The data driver 500 may apply the data voltage Vdat of the determined pattern to the data lines D1-Dm in the data porch period.

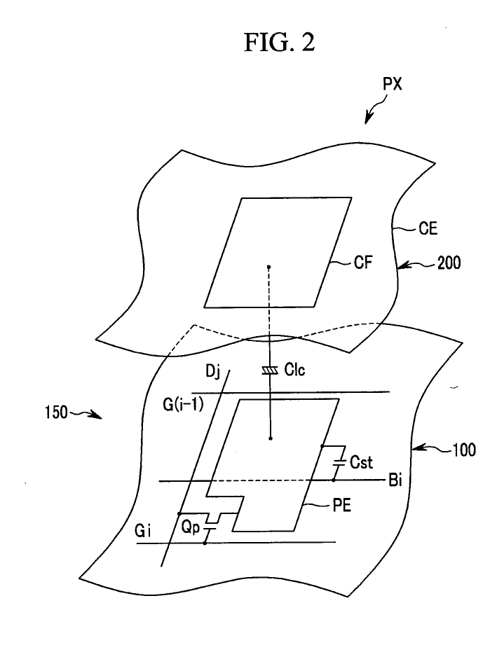

The scan driver 400 is connected to the gate lines G1-Gn of the liquid crystal display panel assembly 300 and applies the image scan signal of the combination of a gate on voltage Von for turning on a switch (FIG. 2, Qp) and a gate off voltage (Voff) for turning off the same to the gate lines G1-Gn.

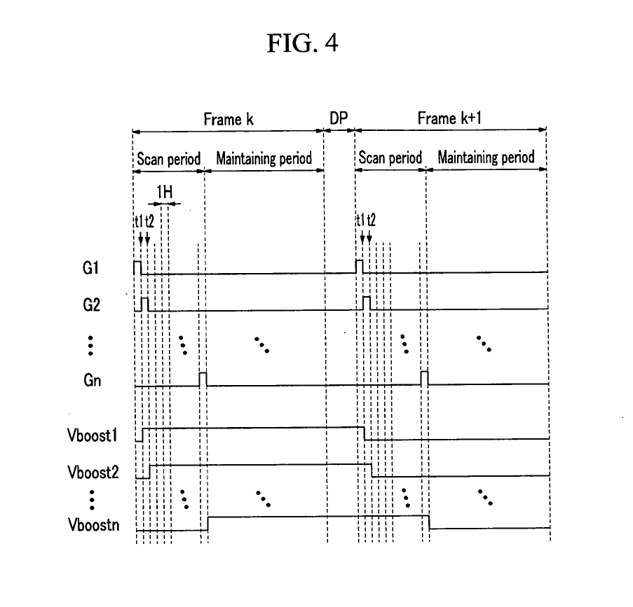

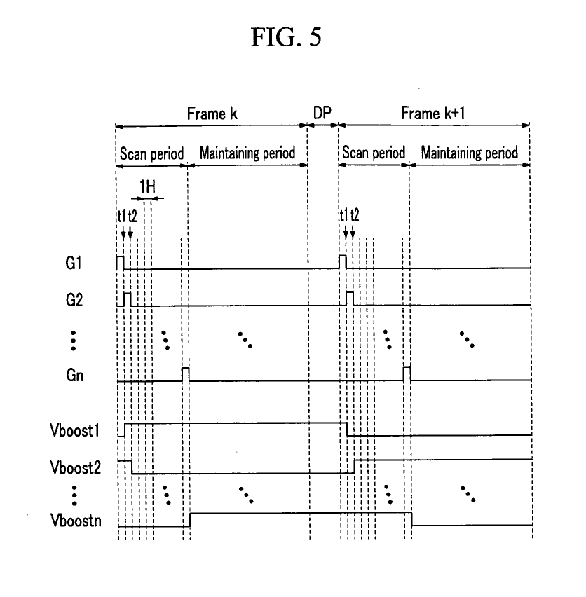

The boost driver 700 transmits a plurality of boost signals to the plurality of boost lines B1-Bn according to the boost control signal CONT3. The levels of the plurality of boost signals are respectively changed in synchronization with the scan signals transmitted to the corresponding gate lines. Also, when the LCD according to an exemplary embodiment is driven according to a line inversion driving method, the plurality of boost signals have an inversion waveform alternately having a high level or a low level as one frame unit, and is an inversion waveform having a predetermined phase difference between neighboring boost signals among the plurality of boost signals. When the LCD according to an exemplary embodiment is driven according to a frame inversion driving method, the plurality of boost signals have an inversion waveform alternately having a high level or a low level as one frame unit, and is the same waveform having a predetermined phase difference between the neighboring boost signals among the plurality of boost signals. A detailed description thereof will be given with reference to FIGS. 4 and 5.

Each of the above-mentioned driving apparatuses 400, 500, 550, 600, and 700 may be directly mounted on the LCD panel assembly 300 in the form of at least one IC chip, may be mounted on a flexible printed circuit film (not shown) and then mounted on the LCD panel assembly 300 in the form of a tape carrier package (TCP), or may be mounted on a separate printed circuit board (not shown). Alternatively, the drivers 400, 500, 550, 600, and 700 may be integrated with the LCD panel assembly 300 together with, for example, the signal lines G1-Gn, D1-Dm, and B1-Bn.

FIG. 2 illustrates an equivalent circuit of one pixel of FIG. 1. Referring to FIG. 2, the LCD panel assembly 300 includes a thin film transistor (TFT) array panel 100 and a common electrode display panel 200 facing to each other, a liquid crystal layer 150 interposed therebetween, and a spacer (not shown) forming a gap between the two display panels 100 and 200 and compressed to some degree.

Referring to one pixel PX of the LCD panel assembly 300, a pixel PX connected to the i-th (i=1−n) gate line G1 and the j-th (j=1−m) data line Dj includes a pixel switch Qp connected to the signal lines G1 and Dj, and a liquid crystal capacitor Clc and a storage capacitor Cst coupled thereto.

The liquid crystal capacitor Clc may include a pixel electrode PE of the thin film transistor array panel 100 and a common electrode CE of the common electrode display panel 200. That is, the liquid crystal capacitor Clc has the pixel electrode PE of the thin film transistor array panel 100 and the common electrode CE of the common electrode display panel 200 as two terminals, with the liquid crystal layer 150 between the pixel electrode PE and the common electrode CE serving as a dielectric material.

The pixel electrode PE may be coupled with the gate line G1 through the pixel switch Qp. The switch Qp may be a three terminal element, e.g., a TFT, provided in the TFT array panel 100, and may include a control terminal connected to the gate line Gi, an input terminal connected to the data line Di, and an output terminal connected to the liquid crystal capacitor Clc and the storage capacitor Cst. Here, the TFT may include amorphous silicon or polycrystalline silicon. The pixel electrode PE is connected to the switch Qp. The common electrode CE is formed on the whole surface of the common electrode display panel 200 and receives a common voltage Vcom. Alternatively, the common electrode CE may be provided on the TFT array panel 100. In this case, at least one of the two electrodes PE and CE may be made in the form of a line or a bar. The common voltage Vcom is a uniform DC voltage of a predetermined level, and may be near 0V.

The storage capacitor Cst may have one terminal coupled with the liquid crystal capacitor Clc, e.g., via the pixel electrode PE, and another terminal coupled with the boost lines Bi. The boost lines Bi may be provided in the TFT array panel 100. The boost lines Bi and the pixel electrode PE may overlap via an insulator. The boost lines Bi may be applied with a predetermined voltage, e.g., the common voltage Vcom.

A color filter CF may be formed on a portion of the region of the common electrode CE of the common electrode display panel 200. Meanwhile, in order to realize color display, each pixel PX may uniquely display one of primary colors (spatial division), or each pixel PX may temporally and alternately display primary colors (temporal division). Then, the primary colors may be spatially or temporally synthesized to realize a desired color. An example of the primary colors may be three primary colors of red, green, and blue.

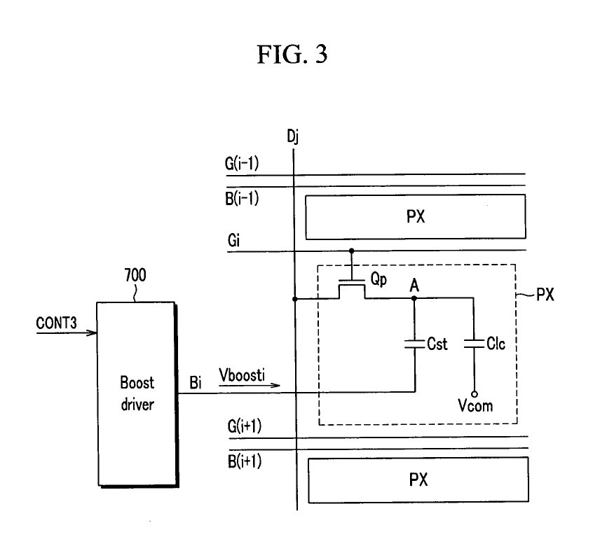

FIG. 3 illustrates a circuit diagram of the LCD shown in FIG. 1. FIG. 3 shows the (i−1)-th to (i+1)-th gate lines G(i−1) to G(i+1), the (i-1)-th to (i+1)-th boost lines B(i−1) to B(i+1), and the pixels PX coupled thereto. One pixel PX includes the liquid crystal capacitor Clc and the storage capacitor Cst. One terminal of the liquid crystal capacitor Clc is coupled to the pixel switch Qp, e.g., via the pixel electrode PE, and the other terminal is applied with the common voltage Vcom. One terminal of the storage capacitor Cst is connected to the liquid crystal capacitor Clc, e.g., via the pixel electrode PE, and the other terminal is connected to the boost lines Bi. A node A is formed between the switch Qp and the liquid crystal capacitor Clc and the storage capacitor Cst. The boost driver 700 applies the boost voltage Vboost to the boost lines Bi according to the boost control signal CONT3.

Referring to FIGS. 1 to 5, the operation of the liquid crystal display (LCD) will be described in detail. FIG. 4 illustrates a waveform diagram to explain an operation of the LCD of FIG. 1 according to an exemplary embodiment. FIG. 5 illustrates a waveform diagram to explain an operation of the LCD of FIG. 1 according to another exemplary embodiment.

Referring to FIGS. 1 to 5, the signal controller 600 receives the video signals R, G, and B from an external graphics controller (not shown), and receives an input control signal that controls the display thereof. The video signals R, G, and B have information corresponding to luminance of each pixel PX. The luminance may be represented by a number of grayscales, e.g., 1024=2¹⁰, 256=2⁸, or 64=2⁶. The input control signal includes, e.g., a vertical synchronization signal Vsync, a horizontal synchronizing signal Hsync, a main clock signal MCLK, and a data enable signal DE.

The signal controller 600 properly processes the input image signals R, G, and B to correspond to an operating condition of the liquid crystal panel assembly 300 and the data driver 500 based on the input video signals R, G, and B and the input control signals, and generates a scan control signal CONT1, a data control signal CONT2, and a boost control signal CONT3. The scan control signal CONT1 is provided to the scan driver 400, the data control signal CONT2 and the processed data signal DAT are provided to the data driver 500, and the boost control signal CONT3 is provided to the boost driver 700.

The data driver 500 receives a digital video signal DAT, selects a gray voltage corresponding to the digital video signal, thereby converting the digital video DAT to an analog image data signal, and then applies the plurality of image data signals of the plurality of pixels PX of one corresponding pixel row among the plurality of pixel rows to the corresponding data lines D1-Dm according to the data control signal CONT2. The scan driver 400 applies a gate-on voltage Von to the gate lines G1-Gn according to the scan control signal CONT1 to turn on the switch Qp connected to the gate lines G1-Gn. Accordingly, the plurality of image data signals that are applied to the data lines D1-Dm are applied to the corresponding pixel PX through the turned-on switch Qp.

The difference between the common voltage Vcom and the data voltage Vdat of the image data signal that is applied to the pixel PX is represented by a charge voltage of the liquid crystal capacitor Clc, i.e., a pixel voltage. Liquid crystal molecules change their arrangement according to a magnitude of the pixel voltage, so that polarization of light passing through the liquid crystal layer 150 changes. The change in the polarization is represented by the change in transmittance of light by the polarizer attached to the LCD panel assembly 300, whereby the pixel PX displays the desired images.

The i-th gate line G(i) is applied with the gate on voltage Von such that the data voltage Vdatj of the image data signal transmitted to the data line Dj is transmitted to the node A. Next, the i-th boost line B(i) connected to the pixel coupled to the i-th gate line G(i) is applied with the boost voltage Vboosti according to the boost control signal CONT3. The boost voltage Vboosti is maintained as the uniform DC voltage during one frame. If the boost voltage Vboost is applied to the i-th boost line B(i), the voltage of the node A is boosted by the coupling. The difference between the voltage of the boosted node A (which may be referred to as a boosted data voltage Vdatj′) and the common voltage Vcom is increased by the change of the boost voltage Vboostj compared with the difference between the non-boosted data voltage Vdat and the common voltage Vcom.

By repeating the process in units of one horizontal period (referred to as “1H”, the same as one period of a horizontal synchronizing signal Hsync and a data enable signal DE), the gate-on voltage Von is sequentially applied to all gate lines G1-Gn and the image data signal is applied to all pixels PX, so that an image of one frame is displayed according to the boosted data voltage by the boost voltage.

If one frame ends and a next frame starts, the data driver 500 generates the data voltage according to the inversion signal RVS so that the polarity of the image data signal applied to each pixel PX is opposite that in a previous frame. This is referred to as frame inversion. At this time, the polarity of the image data signal flowing on one data line may be periodically changed even within one frame according to a characteristic of the inversion signal RVS (for example, row inversion and dot inversion), or the polarity of the image data signal applied to one pixel row may also be changed (for example, column inversion and dot inversion).

As illustrated in FIGS. 4 and 5, a data porch period DP in which the frame synchronization is controlled is provided between a time that one frame ends and a time that the next frame starts. The data driver 500 applies the data voltage Vdat of the determined pattern to the data line D1-Dm during the data porch period DP. The data porch period DP is a blank period between the frames, and may be generally determined as a predetermined period. The data driver 500 may select the data voltage Vdat to be applied to the data line D1-Dm during the data porch period DP in the grayscale voltage generator 550.

In an exemplary embodiment, the plurality of data voltages are sequentially transmitted to the plurality of pixels according to the image scan signal during the scan period, and the pixels emit light according to the data voltages transmitted during the sustain period, thereby driving the LCD. One frame includes the scan period and the sustain period.

FIG. 4 illustrates a waveform when the LCD is driven according to the frame inversion driving method. Referring to FIG. 4, when the first gate line G1 receives the image scan signal at the high level, the image data signals Vdat1-m are applied through the plurality of data lines D1-Dm at the high level, i.e., higher than the common voltage Vcom. Here, for the boosting of the image data signals Vdat1-m, the boost signal of the high level is transmitted to the plurality of pixels PX of the first row through the first boost lines B1 in synchronization to the decreasing time t1 of the gate voltage transmitted to the first gate line G1. Thus, the image data signals Vdat1-m are boosted according to the change amount of the boost signal. The boost signal of the first boost lines B1 maintains the DC voltage of the high level during one frame.

After the one horizontal period 1H, the second gate line G2 receives the image scan signal as the high level, and the image data signals Vdat1-m of the high level are applied through the plurality of data lines D1-Dm. Here, the boost signal of the high level is transmitted to the plurality of pixels PX of the second row through the second boost lines B2 in synchronization with the decreasing time t2 of the gate voltage transmitted to the second gate line G2. Thus, the image data signals Vdat1-m are boosted according to the change amount of the boost signal. The boost signal of the second boost lines B2 maintains the DC voltage of the high level during one frame.

In the above mentioned method, the plurality of pixels receive the plurality of image data signals corresponding to the first gate line G1 to the n-th gate line Gn during the scan period, and emit light according to the image data signals transmitted during the sustain period, thereby displaying the images of one frame.

After the image data of one frame is displayed, the image data signals Vdat1-m are applied as the low level, i.e., lower than the common voltage Vcom, in the next frame according to the inversion signal RVS applied to the data driver 500, and the boost signal for the boosting of the image data signals Vdat1-m is applied at the low level, thereby boosting the image data signals Vdat1-m at the low level.

FIG. 5 illustrates a waveform when the LCD is driven according to the row inversion driving method. Referring to FIG. 5, when the first gate line G1 receives the image scan signal as the high level, the image data signals Vdat1-m are applied through the plurality of data lines D1-Dm as the high level, i.e., higher than the common voltage Vcom. Here, for the boosting of the image data signals Vdat1-m, the boost signal of the high level is transmitted to the plurality of pixels PX of the first row through the first boost lines B1 in synchronization with the decreasing time t1 of the gate voltage transmitted to the first gate line G1. The boost signal of the first boost lines B1 maintains the DC voltage of the high level during one frame.

After the one horizontal period 1H, when the second gate line G2 receives the image scan signal at the high level, the image data signals Vdat1-m are applied at the low level, i.e., lower than the common voltage Vcom, through the plurality of data lines D1-Dm. Here, the boost signal of the low level is applied to the plurality of pixels PX of the second row through the second boost lines B2 in synchronization with the decreasing time t2 of the gate voltage transmitted to the second gate line G2. Thus, the image data signals Vdat1-m are boosted according to the change amount of the boost signal. The boost signal of the second boost lines B2 maintains the DC voltage of the low level during one frame.

As the above mentioned method, the plurality of pixels receive the plurality of image data signals corresponding to the first gate line G1 to the n-th gate line Gn during the scan period, and emit the light according to the image data signals transmitted during the sustain period, thereby displaying the images of one frame.

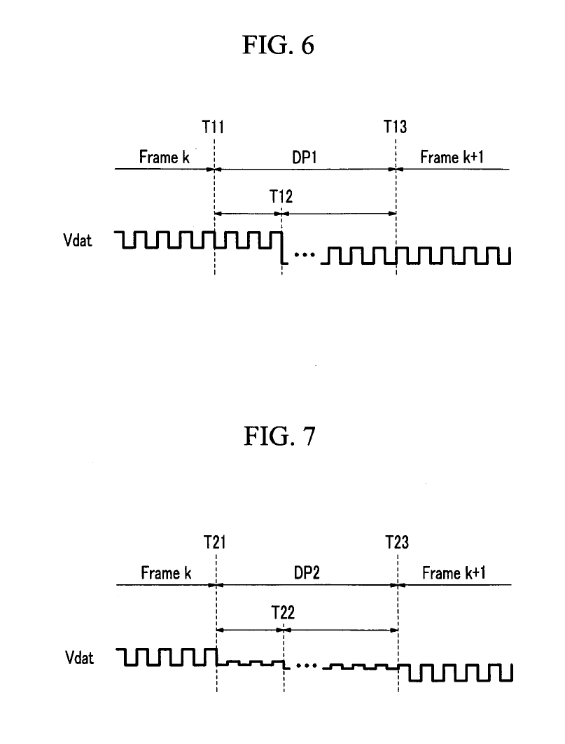

As shown in FIGS. 4 and 5, the pixels PX corresponding to the gate line G1 to the gate line Gn may sequentially display the image data of one frame through the frame inversion driving method or the row inversion driving method. After the image data of one frame is displayed, the data voltage of the determined waveform is applied to the plurality of data lines D1-Dm during the data porch period DP before the image data of the next frame is displayed, and the detailed description thereof will be given with respect to FIGS. 6 to 8.

Next, the operation of the LCD applying the data voltage Vdat of the determined pattern through the plurality of data lines D1-Dm during the data porch period will be described. An example in which the data voltage Vdat is applied to an arbitrary data line among the plurality of data lines D1-Dm will be described. The plurality of data lines D1-Dm may receive the data voltage Vdat through the same method with which the arbitrary data line is applied with the data voltage.

FIG. 6 illustrates a waveform of a data voltage applied to one data line among a plurality of data lines in a data porch period DP1 according to an exemplary embodiment. Referring to FIG. 6, the data driver 500 applies the same data voltage as the data voltage applied in the previous frame k to the data line with the same pattern during the determined period at the time that the data porch period DP1 is started, and applies the same data voltage as the data voltage to be applied in the next frame k+1 to the data line with the same pattern during the determined period before the time that the data porch period DP1 is finished.

That is, the data driver 500 applies the plurality of data voltages of the predetermined period before the k frame is finished to the plurality of data lines during the first period among the data porch period, and applies the plurality of data voltages to be applied during the predetermined period after the k+1 frame is started to the plurality of data lines during the second period among the data porch period DP1. Here, the first period and the second period are included in the data porch period DP1.

For example, the data voltage applied to the data line Dj among the plurality of data lines during the data porch period is described with reference to FIG. 6. In an exemplary embodiment, the LCD is driven through the method that a plurality of data voltages are sequentially applied to a plurality of pixels according to the image scan signal during the scan period, and the pixels emit light according to the transmitted data voltage during the sustain period.

As shown in FIG. 6, the data porch period DP1 exists between the k-th frame and the (k+1)-th frame. The period before the time T11 is the sustain period of the k-th frame and the period after the time T13 is the scan period of the (k+1)-th frame.

The plurality of data voltages may be set up as the voltage alternately having the data voltage input to the gate lines Gn-1 and Gn among the k-th frame during the first period between the time T11 and the time T12. FIG. 6 only shows the data voltage Vdatj transmitted to one data line Dj among the plurality of data lines.

The plurality of data voltages may be set up as the voltage alternately having the data voltage input to the gate lines G1 and G2 among the (k+1)-th frame during the second period between the time T12 and the time T13.

In other words, in the data porch period DP1, the data voltage of the same waveform as that applied in the frame (k-th or (k+1)-th frame) is applied to the data line in respective portions of the data porch period DP1 for each data line, such that the data porch period may be reduced. Accordingly, the change width of the data voltage may be reduced in the data porch period and the flicker may be improved.

FIG. 7 illustrates a waveform of a data voltage applied to one data line among a plurality of data lines in a data porch period DP2 according to another exemplary embodiment. Referring to FIG. 7, the data driver 500 applies the arbitrary data voltage minimizing the coupling influence from the boost lines B1-Bn to the data line during the data porch period DP2 according to a predetermined pattern. The data porch period DP2 exists between the k-th frame and the (k+1)-th frame. The period before the time T21 is the sustain period of the k-th frame and the period after the time T23 is the scan period of the (k+1)-th frame.

For example, during a first period of the data porch period DP2, i.e., from an end of the frame k (hereinafter, a positive frame) at time T21 to a time T22 within the data porch period T22, the data driver 500 may apply a voltage signal alternating between two voltages, e.g., 2.0V and 2.1V, both within a middle range of the voltages applied during the positive frame. During a second period of the data porch period DP2, i.e., from an the time T22 to a start of the frame k+1 (hereinafter, a negative frame), the data driver 500 may apply a voltage signal alternating between two voltages, e.g., 1.5V and 1.6V, both within a middle range of voltages applied during the negative frame. Similarly, the data driver 550 may alternately apply 1.5 to 1.6V during the data porch period after the negative frame ends, and 2.0 to 2.1V during the data porch period before the positive frame starts.

As described above, the voltage of the middle range of the positive voltage value or the negative voltage value is applied to the data line in the data porch period such that the coupling influence of the boost lines by the data voltage may be reduced, thereby reducing flicker.

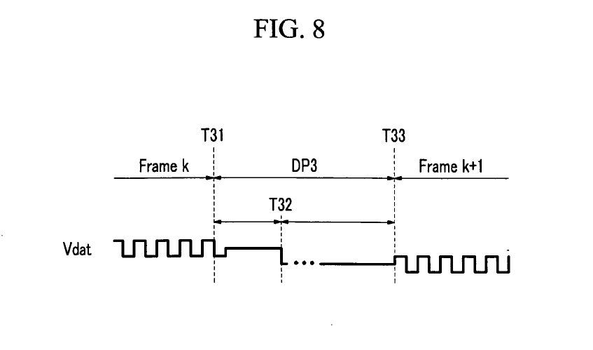

FIG. 8 illustrates a waveform of a data voltage applied to one data line among a plurality of data lines in a data porch period DP3 according to another exemplary embodiment of the present invention. Referring to FIG. 8, during a first period T31-T32 of the data porch period DP3, the data driver 500 applies some fraction, e.g., ½, of the maximum data voltage applied during the positive frame to the data line as a DC voltage. During a second period T32-T33 of the data porch period DP3, the data driver 300 applies some fraction, e.g., ½, of the minimum voltage applied during the negative frame as a DC voltage. Similarly, the data driver 500 may apply ½ the maximum voltage of the positive frame as a DC voltage to the data line in the data porch period DP3 before the start of the positive frame, and may apply the ½ the minimum voltage of the negative frame as a DC voltage to the data line in the data porch period DP3 after the finish of the negative frame. That is, the data driver 500 applies a fractional DC voltage of the positive frame or the negative frame adjacent that portion of the data porch period DP3, so as not to generate the change of the data voltage for the polarity in the data porch period DP3.

As described above, according to embodiments, the change width of the data voltage in the data porch period may be minimized such that the coupling influence to the ALS signal is minimized, and flicker may be reduced. Accordingly, embodiments may provide a liquid crystal display (LCD) and a driving method thereof that reduce flicker in the ALC driving method.

As described above, the fractional, e.g., ½, the voltage level of the data voltage of the positive frame or the negative frame is applied to the data line in the data porch period such that the coupling influence of the boost lines by the data voltage is reduced or eliminated. Thus, flicker may be reduced.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

### DESCRIPTION OF SYMBOLS

100: thin film transistor array panel
150: liquid crystal layer
200: common electrode display panel
300: liquid crystal display panel assembly
400: scan driver
500: data driver
550: gray voltage generator
600: signal controller
700: boost driver

What is claimed is:

1. A display device, comprising:
a display panel including a plurality of pixels;
a data driver connected to the display panel, the data driver applying an image data signal to the plurality of pixels;
a scan driver connected to the display panel, the scan driver applying an image scan signal to the plurality of pixels for the image data signal to be applied to the plurality of pixels; and
a signal controller controlling the data driver and the scan driver,
wherein the data driver applies a data signal having a predetermined pattern to the display panel in a data porch period for adjusting synchronization between frames.

2. The display device as claimed in claim 1, wherein:
the data signal having the predetermined pattern in the data porch period has a same period as the image data signal applied in the frame before the data porch period.

3. The display device as claimed in claim 1, wherein:
the data signal having the predetermined pattern in the data porch period has the same period as the image data signal applied in the frame after the data porch period.

4. The display device as claimed in claim 1, wherein:
the data signal having the predetermined pattern in the data porch period includes a positive intermediate value between a positive voltage applied in the frame adjacent the data porch period and the common voltage.

5. The display device as claimed in claim 4, wherein the data signal having the predetermined pattern in the data porch period alternates between the common voltage and the positive intermediate value.

6. The display device as claimed in claim 4, wherein the data signal is a DC voltage of the intermediate value.

7. The display device as claimed in claim 6, wherein the intermediate value is ½ the positive voltage applied in the frame adjacent the data porch period.

8. The display device as claimed in claim 1, wherein
the data voltage having the predetermined pattern in the data porch period includes a negative intermediate value between a negative voltage applied in the frame adjacent the data porch period and the common voltage.

9. The display device as claimed in claim 8, wherein the data signal having the predetermined pattern in the data porch period alternates between the common voltage and the negative intermediate value.

10. The display device as claimed in claim 8, wherein the data signal is a DC voltage of the intermediate value.

11. The display device as claimed in claim 10, wherein the intermediate value is ½ the negative voltage applied in the frame adjacent the data porch period.

12. The display device as claimed in claim 1, further comprising
a gray voltage generator providing a grayscale voltage to the data driver in the data porch period.

13. A method for driving a display device having a plurality of pixels, the method comprising:
applying an image data signal to the plurality of pixels;
applying an image scan signal to the plurality of pixels for the image data signal to be applied to the plurality of pixels thereby displaying an image of a frame; and
applying a data voltage of a predetermined pattern to the plurality of pixels in a data porch period between a completion of the display of a first frame and a start of a second frame.

14. The method as claimed in claim 13, wherein applying the data voltage of the data porch period further includes selecting grayscale data voltages to be applied.

15. The method as claimed in claim 13, wherein applying the data voltage of the predetermined pattern to the plurality of pixels in the data porch period includes applying the image data signal.

16. The method as claimed in claim 13, wherein applying the data voltage of the predetermined pattern to the plurality of pixels in the data porch period includes:
applying the image data signal of the first frame during a first period at a start of the data porch period; and
applying the image data signal of the second frame during a second period at an end of the data porch period.

17. The method as claimed in claim 13, wherein applying the data voltage of the predetermined pattern includes:
applying a first intermediate voltage during a first period at a start of the data porch period, the first intermediate voltage being between the common voltage and a data voltage of the first frame; and
applying a second intermediate voltage during a second period at an end of the data porch period, the second intermediate voltage being between the common voltage and a data voltage of the second frame.

18. The method as claimed in claim 17, wherein applying the data signal of the predetermined pattern includes applying the first intermediate voltage as a DC voltage during the first period and applying the second intermediate voltage as a DC voltage during the second period.

19. The method as claimed in claim 18, wherein the first and second intermediate voltages are halfway between the common voltage and the data voltages of the first and second frames, respectively.

20. The method as claimed in claim 17, wherein applying the data signal of the predetermined pattern includes alternately applying the first intermediate voltage and the common voltage during the first period, and alternately applying the second intermediate voltage and the common voltage during the second period.
